(19) United States
(12) Patent Application Publication
(10) Pub. No.: US 2011/0233193 A1
(43) Pub. Date: Sep. 29, 2011

(54) FLEXIBLE, FLAT HEATING STRIP USING CARBON FILAMENTS AS HEATING ELEMENT

(75) Inventor: Chen San CHENG, Taichung City (TW)

(73) Assignee: CHEN SAN CHENG, Taichung City (TW)

(21) Appl. No.: 13/072,940

(22) Filed: Mar. 28, 2011

(30) Foreign Application Priority Data
Mar. 29, 2010 (TW) 99205421

(51) Int. Cl. H05B 3/34

(52) U.S. Cl. 219/549

(57) ABSTRACT

The present invention provides a flexible, flat heating strip using carbon filaments as a heating element, which includes: multiple carbon filaments; a thermoplastic material applied to two opposite surfaces of the carbon filaments to enclose them; and a power terminal provided at each of two opposite end portions of the carbon filaments. The flexible, flat heating strip can be of any size and can be extended when necessary. For example, a plurality of flexible, flat heating strips may be soldered together in series to extend and form a predetermined pattern; also, a single flexible, flat heating strip may be bent consecutively to form a predetermined pattern. A flexible, flat heating strip of the present invention is suitable for use with articles of all dimensions, including small articles (e.g., clothing, waist supports, and gloves) and large-area items (e.g., electric blankets, quilts).

### BACKGROUND OF THE INVENTION

1. Field of the Invention

The present invention relates to flexible, flat heating strips, and more particularly, to a flexible, flat heating strip using carbon filaments as a heating element.

2. Description of the Prior Art

Due to their flexibility, light weight and compactness, flexible heating pads are widely applicable to articles, such as clothing, knee pads, waist supports, gloves, shoe pads, earmuffs, or back supports, for covering and warming parts of the human body.

A conventional flexible heating pad essentially comprises: a metal circuit made from a metal sheet through a chemical etching or stamping process;, two soft and heat-resistant insulating elements stacked up to sandwich the metal circuit therebetween; and two power supply wires which are connected to two end portions of the metal circuit and protrude from the two insulating elements, such that an electric current can pass through the metal circuit to generate heat. Another conventional type of flexible heating pad comprises: a first soft and heat-resistant insulating element; a carbon circuit provided on the first soft and heat-resistant insulating element through a printing process; and a second soft and heat-resistant insulating element stacked on the first soft and heat-resistant insulating element such that the carbon circuit is sandwiched therebetween. Likewise, the heating pad comprises two power supply wires which are connected to two end portions of the carbon circuit and protrude from the two insulating elements, respectively. Although the above two conventional flexible heating pads are light and compact, they can only be bent slightly but cannot be bent at a larger angle. As a result, applications of these two conventional flexible heating pads are rather limited.

Yet another conventional type of flexible heating pad comprises: two protective sheets; an electrically conductive fabric, such as a carbon fiber fabric, sandwiched between the two protective sheets; and a power input. Such flexible heating pad has relatively high applicability because it is light, compact, and can be bent at any angle.

Taiwan Patent 1308465 discloses a method for manufacturing a flexible heating pad using an electrically conductive fabric as a heating element. The method comprises the steps of: providing an electrically conductive fabric and a supporting element, wherein the supporting element comprises a PET film and an acrylic adhesive adhering to one side of the PET film; adhering the acrylic adhesive to one side of the electrically conductive fabric by pressing, such that the PET film and the electrically conductive fabric are coupled together; stamping the electrically conductive fabric to form a heating element having a predetermined circuit pattern; applying a conductive gel to two end points of the heating element for adhering to a power supply wire respectively, and then applying a flexible protective pad made of a thermoplastic material to the other side of the heating element which is not affixed to the PET film; removing the PET film and then applying another flexible protective pad made of a thermoplastic material to the side not covered by the flexible protective pad, so as to finalize the fabrication of the flexible heating pad. However, this method requires an additional mold to be created in order to form a predetermined circuit pattern on the electrically conductive fabric by stamping, thereby making the fabrication process complicated and costly. Also, a flexible heating pad thus manufactured is only suitable for use with small articles, such as clothing, knee pads, waist supports, gloves, shoe pads, earmuffs, or back supports, but is not suitable for items with a large area, such as electric blankets or quilts. Accordingly, the conventional method for manufacturing a flexible heating pad using an electrically conductive fabric as a heating element has its drawbacks and needs improvement.

### SUMMARY OF THE INVENTION

It is an objective of the present invention to provide a flexible, flat heating strip which uses carbon filaments as a heating element. The present invention features a manufacturing process which is simplified since no extra molds are needed; thus, the manufacturing process can speed up while the cost is lowered. Moreover, a flexible, flat heating strip of the present invention can be of any size and can be extended when necessary; it is suitable for use with articles of all dimensions, including small articles (e.g., clothing, waist supports, and gloves), and large-area items (e.g., electric blankets, quilts).

In order to achieve the above and other objectives, the present invention provides a flexible, flat heating strip using carbon filaments as a heating element. The flexible, flat heating strip comprises: multiple carbon filaments; a thermoplastic material applied to two opposite surfaces of the carbon filaments to enclose them; and a power terminal provided at each of two opposite end portions of the carbon filaments.

Preferably, the power terminal is a ring made of an electrically conductive metallic material and is flattened to completely enclose the multiple carbon filaments.

Preferably, a portion of the power terminal is received in the thermoplastic material, and the other portion of the power terminal protrudes from the thermoplastic material.

Preferably, the power terminal can be connected to an external power.

Preferably, the thermoplastic material is heat-resistant.

Preferably, a plurality of flexible, flat heating strips are soldered together in series to extend and form a predetermined pattern.

Preferably, the flexible, flat heating strip is bent consecutively to form a predetermined pattern.

### BRIEF DESCRIPTION OF THE DRAWINGS

FIG. 1 is a schematic view of a flexible, flat heating strip using carbon filaments as a heating element according to the present invention;

FIG. 2A and FIG. 2B are cross-sectional views of the flexible, flat heating strip taken along line A-A and line B-B of FIG. 1, respectively;

FIG. 3 is a schematic view of a plurality of flexible, flat heating strips connected in series to extend;

FIG. 4 is a schematic view of a flexible, flat heating strip that is bent consecutively; and

FIG. 5 is a schematic view of an electric blanket comprising the flexible, flat heating strip that is bent consecutively.

### DETAILED DESCRIPTION OF THE PREFERRED EMBODIMENTS

The present invention will be fully described by reference to the appended drawings for illustrating the preferred embodiments of the present invention. Prior to the description, it should be understood that persons skilled in the art can amend the invention described in the specification and still obtain the benefits of the present invention. Hence, it should be understood that, from the perspective of persons skilled in the art, the description is a broad disclosure and its embodiments are not limited those disclosed in the present invention.

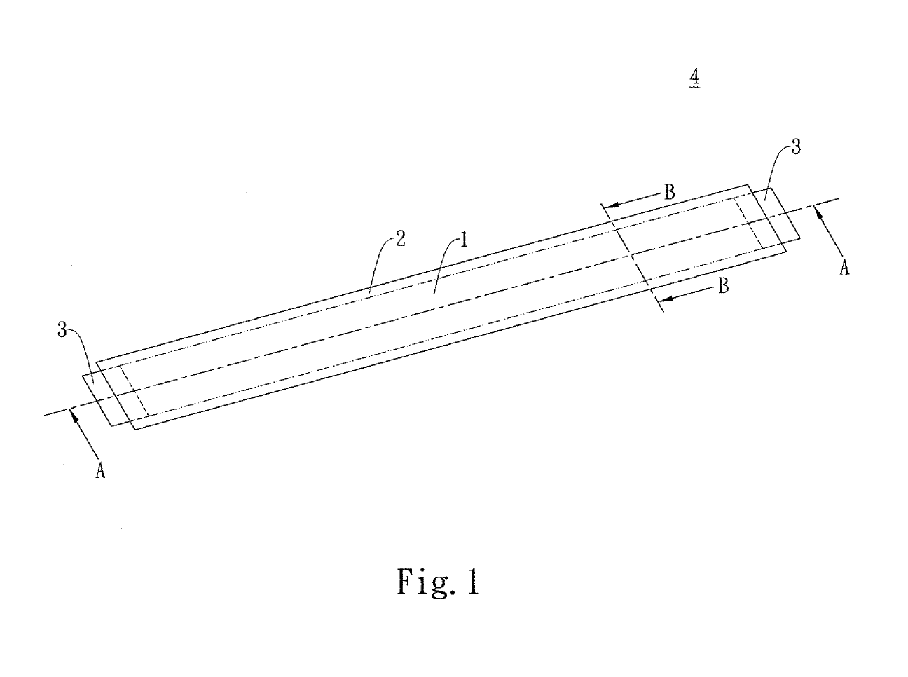

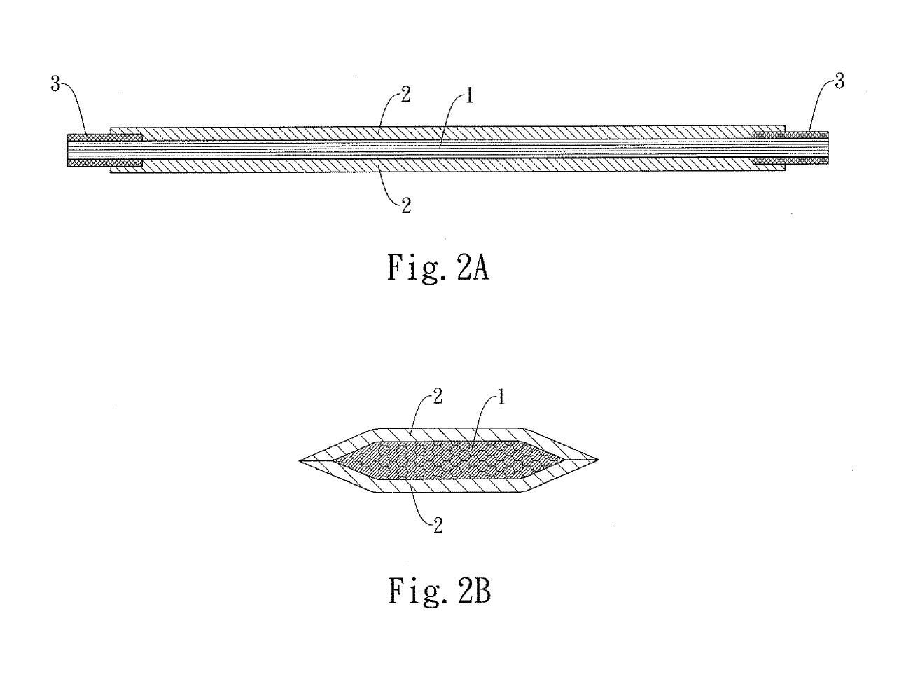

Referring to FIG. 1, there is shown a schematic view of a flexible, flat heating strip 4 using carbon filaments 1 as a heating element according to the present invention. Referring to FIG. 2A and FIG. 2B, there are shown cross-sectional views of the flexible, flat heating strip 4 taken along line A-A and line B-B of FIG. 1, respectively. The flexible, flat heating strip 4 using the carbon filaments 1 as a heating element according to the present invention comprises: multiple carbon filaments 1; a thermoplastic material 2 applied to two opposite surfaces of the carbon filaments 1 to enclose them; and a power terminal 3 provided at each of two opposite end portions of the carbon filaments 1. The power terminal 3 is a ring made of an electrically conductive metallic material. The ring is flattened in a manner that it can completely enclose the carbon filaments 1. A portion of the power terminal 3 is received in the thermoplastic material 2. The other portion of the power terminal 3 protrudes from the thermoplastic material 2. The power terminal 3 is connected to an external power source (not shown). Upon connection of the power terminal 3 and the external power source, an electric current will pass through the carbon filaments 1, and the carbon filaments 1 generates heat and functions as a heating element. The thermoplastic material 2 is heat-resistant and functions as a protective layer.

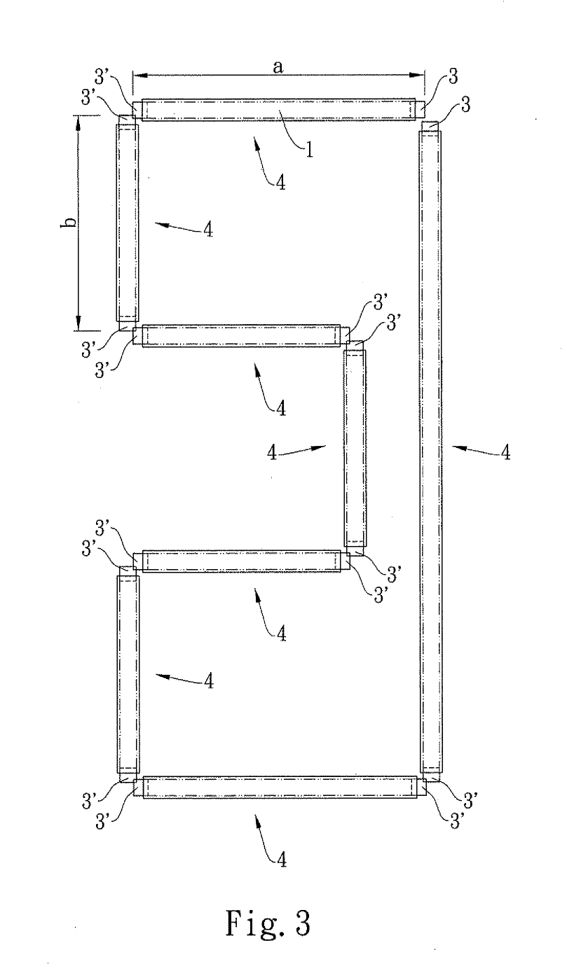

Referring to FIG. 3, there is shown a schematic view of a plurality of flexible, flat heating strips 4 connected in series to extend longer. In this embodiment, the flexible, flat heating strips 4 are soldered together at the power terminals 3′ and vertically connected in series to form a predetermined pattern. It should be noted that the flexible, flat heating strips 4 are soldered to each other at any angle, such as 90° as shown in the drawing. The number of flexible, flat heating strips 4 may vary to form a predetermined pattern as needed, so that they are applicable to small articles (e.g., clothing, waist supports, and gloves) or large-area items (e.g., electric blankets, quilts) and function as an heating equipment for parts of the body. The lengths a, b shown in FIG. 3 are equal; however, they are changeable and can be different when needed. In the predetermined pattern of this embodiment, as soon as the power terminal 3 above and the power terminal 3 below are both connected to an external power source (not shown), an electric current will pass through the carbon filaments 1, which begin to generate heat and function as a heating element.

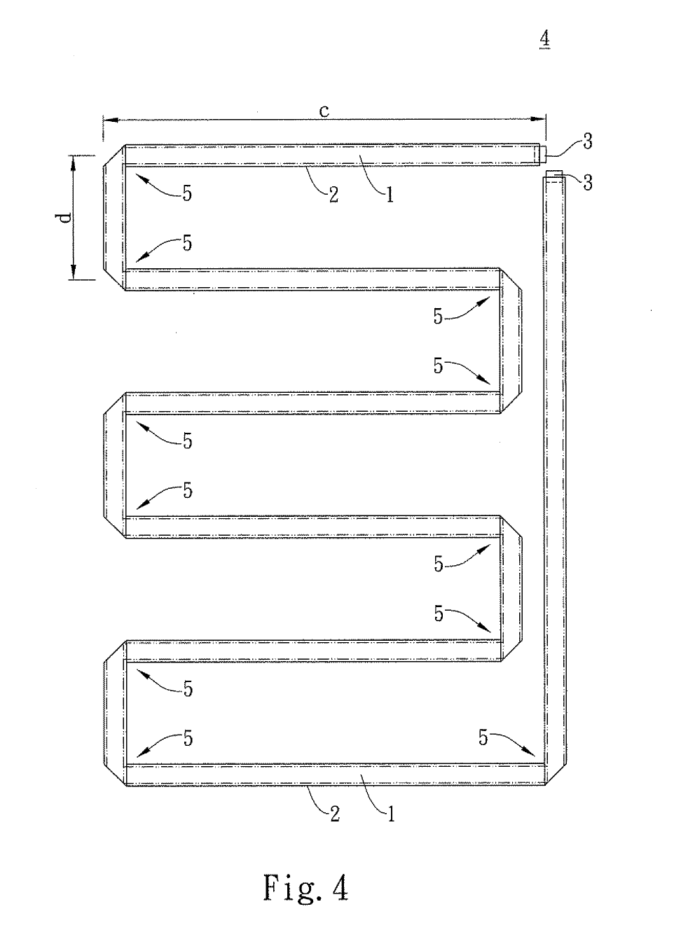

Referring to FIG. 4, there is shown a schematic view of a flexible, flat heating strip 4 that is bent consecutively. In this embodiment, the flexible, flat heating strip 4 is bent consecutively (with a plurality of bends indicated by reference numeral 5) to form a predetermined pattern. It should be noted that the bends can be of any angle, such as 90° as shown in the drawing. The flexible, flat heating strip 4 can be bent as many times as needed to form a predetermined pattern, so that it can be applied to small articles (e.g., clothing, waist supports, and gloves) or large-area items (e.g., electric blankets, quilts) to function as an external heating equipment for parts of the body. The lengths c, d shown in FIG. 4 are different; however, they are changeable and can be equal when needed. In the predetermined pattern of this embodiment, as soon as the two power terminals 3 are both connected to an external power source (not shown), an electric current will pass through the carbon filaments 1, which begin to generate heat and function as a heating element.

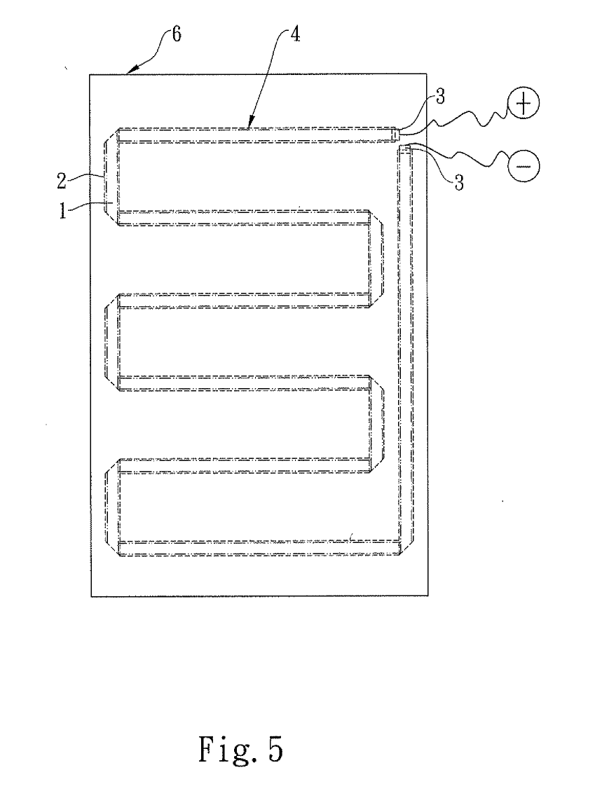

Referring to FIG. 5, there is shown a schematic view of an electric blanket 6 comprising the flexible, flat heating strip 4 that is bent consecutively. In this embodiment, the electric blanket 6 encloses a predetermined pattern formed by the flexible, flat heating strip 4. As soon as the two power terminals 3 are connected to an external power source (as indicated by the positive and negative terminals shown in FIG. 5), an electric current will pass through the carbon filaments 1 of the flexible, flat heating strip 4; thus, the carbon filaments 1 begin to generate heat and function as an heating element.

A flexible, flat heating strip of the present invention has the following advantages. It uses carbon filaments as a heating element, can be of any size, and can be extended when needed. For example, a plurality of flexible, flat heating strips may be soldered together in series to extend and form a predetermined pattern; also, a single flexible, flat heating strip may be bent consecutively to form a predetermined pattern. A flexible, flat heating strip of the present invention is suitable for use with articles of all dimensions, including small articles (e.g., clothing, waist supports, and gloves) and large-area items (e.g., electric blankets, quilts).

he present invention is disclosed above with preferred embodiments. Persons skilled in the art shall understand that various modifications and changes can be made to the aforesaid embodiments without departing from the scope and spirit of the appended claims, and that embodiments of the present invention are not limited herein.

What is claimed is:

1. A flexible, flat heating strip using carbon filaments as a heating element, the flexible, flat heating strip comprising:
multiple carbon filaments;
a thermoplastic material provided at two opposite surfaces of the multiple carbon filaments to enclose them; and
a power terminal provided at each of two opposite end portions of the multiple carbon filaments.

2. The flexible, flat heating strip of claim 1, wherein the power terminal is a ring made of an electrically conductive metallic material and is flattened to completely enclose the multiple carbon filaments.

3. The flexible, flat heating strip of claim 1, wherein a portion of the power terminal is received in the thermoplastic material, and the other portion of the power terminal protrudes from the thermoplastic material.

4. The flexible, flat heating strip of claim 1, wherein the power terminal can be connected to an external power source.

5. The flexible, flat heating strip of claim 1, wherein the thermoplastic material is heat-resistant.

6. The flexible, flat heating strip of claim 1, wherein a plurality of flexible, flat heating strips are soldered together in series to extend and form a predetermined pattern.

7. The flexible, flat heating strip of claim 1, wherein the flexible, flat heating strip is bent consecutively to form a predetermined pattern.
